(19) United States
(12) Patent Application Publication
(10) Pub. No.: US 2008/0017196 A1
(43) Pub. Date: Jan. 24, 2008

(54) Respiratory hood system

(76) Inventor: Natalia Kamneva, Monroeville, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/879,262

(22) Filed: Jul. 17, 2007

Related U.S. Application Data
(60) Provisional application No. 60/831,433, filed on Jul. 18, 2006.

(51) Int. Cl. A62B 17/04

(52) U.S. Cl. 128/201.23

(57) ABSTRACT

A respiratory hood system to prevent contaminants from coming into contact with a user's face, including a respiratory mask and a hood member. The hood member includes a facial portion that is substantially transparent and breathable, wherein the facial portion does not substantially restrict the user's vision. The hood member also includes a hood portion attached to the facial portion and configured to cover a portion of the user's head that is not covered by the facial portion.

### CROSS-REFERENCE TO RELATED APPLICATIONS

This application claims the benefit of U.S. Provisional Patent Application No. 60/831,433, filed on Jul. 18, 2006, and entitled “Shield Guard”, the entire disclosure of which is incorporated herein by reference.

### BACKGROUND OF THE INVENTION

1. Field of the Invention

The present invention relates generally to disease prevention and epidemiology, and, more particularly, to a respiratory hood system to protect wearers who are in close proximity to disease-causing agents from contracting such diseases.

2. Description of Related Art

For those who work with or near people who have contracted communicative diseases, preventing the spread of such diseases is a primary concern. Several devices have been developed over the years to help contain disease-causing agents. Respiratory masks similar to those worn by surgeons can be worn over an afflicted person's nose and mouth to prevent the disease from spreading to others through respiration. Likewise, medical professionals can wear such respiratory masks to prevent them from inhaling disease-causing agents, and also to prevent the spread of foreign agents from them to their patients through respiration. However, many communicative diseases can be spread through contact with a person's face, eyes, nose and mouth, often due to the person touching their face with their contaminated hands. Conventional respirator masks do not adequately protect against such means of disease spreading. While hand washing is an effective way to combat such contamination, it is often impractical for people to perform the necessary frequency of hand washing that is effective in disease-ridden conditions.

### SUMMARY OF THE INVENTION

The present invention involves a respiratory hood system that prevents contaminants, such as viruses, bacteria, or other biohazardous materials, from coming into contact with a user's face. The hood system includes a respiratory mask and a hood member. The hood member includes a facial portion that has a substantially transparent and breathable material, wherein the facial portion does not substantially restrict the user's vision. The hood member also includes a hood portion attached to the facial portion and configured to substantially cover a portion of the user's head that is not covered by the facial portion.

The present invention also involves a respiratory hood for use with a respiratory mask which includes a facial portion and a hood portion. The facial portion has a substantially transparent and breathable material, wherein the facial portion does not substantially restrict the user's vision. The hood portion is attached to the facial portion and configured to substantially cover a portion of the user's head that is not covered by the facial portion.

The present invention also involves a method for protecting contaminants from coming into contact with a user's face. The method includes placing a respiratory mask over the user's nose and mouth and placing a respiratory hood over the user's head. The respiratory hood includes a facial portion and a hood portion. The facial portion has a substantially transparent and breathable material that does not substantially restrict the user's vision. The hood portion is attached to the facial portion and configured to substantially cover a portion of the user's head that is not covered by the facial portion.

### BRIEF DESCRIPTION OF THE DRAWINGS

FIG. 1 is a front view of the respiratory hood system;

FIG. 2 is a side view of the respiratory hood system;

FIG. 3 is a perspective view of the respiratory hood system;

FIG. 4 is a front view of the respiratory hood system with the drawstring being tied around the neck;

FIG. 5 is a side view of the respiratory hood system with the drawstring being tied around the neck;

FIG. 6 is a front view of the respiratory hood system with a smaller facial portion;

FIG. 7 is a front view of an alternative embodiment of the respiratory hood system without the hood portion;

FIG. 8 is a side view of the respiratory hood with the drawstring being threaded to tie in the back of the head; and

FIG. 9 is a rear view of the respiratory hood with the drawstring being threaded to tie in the back of the head.

FIG. 10 is a front view of the respiratory hood with the respiratory mask sewn into the facial portion.

FIG. 11 is a side view of the respiratory hood with the respiratory mask sewn into the facial portion.

### DETAILED DESCRIPTION OF THE INVENTION

The present invention will now be described with reference to the accompanying figures. For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is to be understood that the specific system illustrated in the attached figures and described in the following specification is simply an exemplary embodiment of the present invention. Hence, specific dimensions and other physical characteristics related to the embodiments disclosed herein are not to be considered as limiting.

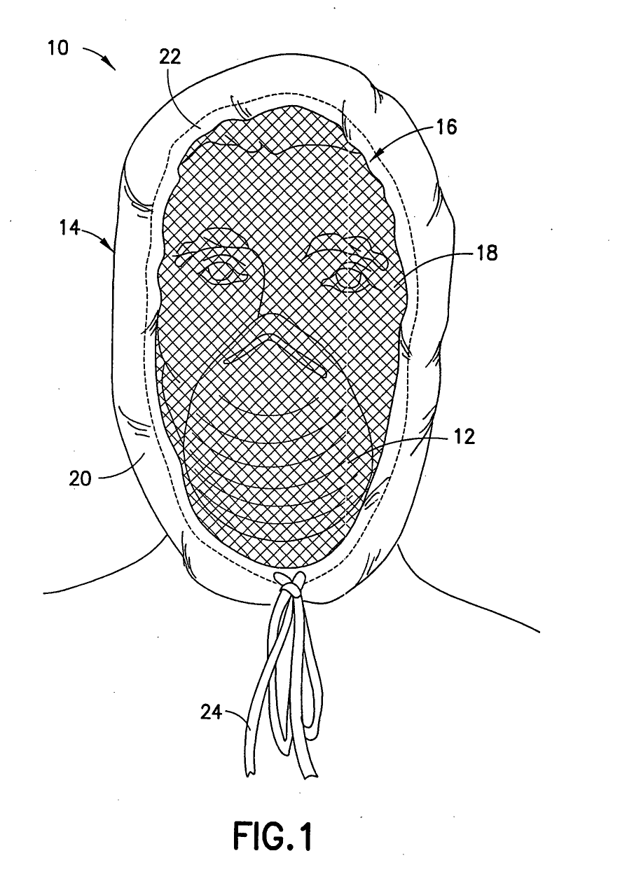

FIGS. 1-3 show a front, side and perspective view of a respiratory hood system 10 worn over a user's head. The system 10 includes a respiratory mask 12 that is configured to cover the user's nose and mouth. The mask 12 is tied or otherwise secured to the user's head such that it remains in place over the user's nose and mouth. The respiratory mask 12 is desirably made of a porous material that allows air to flow through it, such that a user's breathing is not substantially obstructed, but such that contaminants (e.g., viruses and bacteria) that may be airborne cannot penetrate the mask 12. Desirably, the mask 12 material is flexible enough to conform closely to the user's face so that most, if not all, of the air that is breathed in or out by the user will travel through the mask. This ensures that airborne contaminants will be trapped in the mask 12 and will not infect the user. Typical respiratory masks, such as those used by surgeons, doctors and other medical professionals are well-known in the art and are suitable for the purposes of the present invention. Additionally, respiratory masks, such as those used by painters or construction workers, may also be suitable since they are designed to prevent airborne particulate matter from being inhaled.

The respiratory hood system 10 also includes a hood member 14 that fits over the user's head. The hood member 14 has a facial portion 16 that is sized and configured to cover the user's face. The facial portion 16 is made from a breathable material. By “breathable,” it is meant that the material does not obstruct or substantially impede the user's breathing while wearing the hood member 14. The breathability of the facial portion 16 is by virtue of a plurality of openings 18 in the facial portion 16. The openings 18 also cause the facial portion 16 to be substantially transparent, i.e., the user's vision is not substantially obstructed, such that a user can perform manual functions that require the ability to see what the user is doing. For example, a user of the hood system 10 should be able to administer medications, read and write without difficulties due to obstructed vision. Natural or synthetic fibers or paper materials made into mesh or netting are suitable for the facial portion, though other materials will be known to those having ordinary skill in the art.

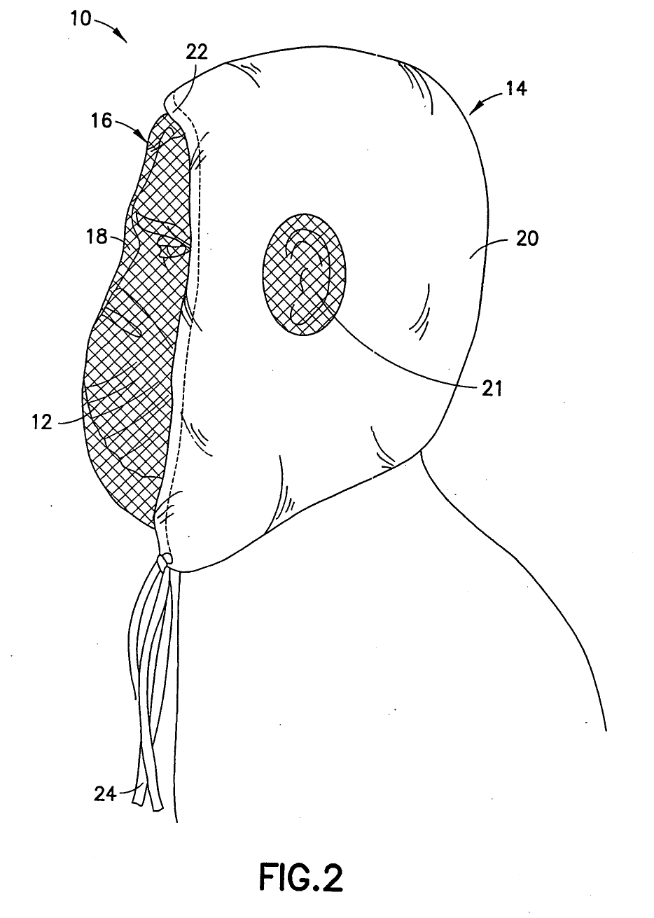

In addition to allowing the user to see through the facial portion 16, the facial portion 16 also protects the user from having contaminated objects, such as the user's hands, come into contact with the user's face. Accordingly, the openings 18 generally are sized and configured so that a contaminated object that comes into contact with the facial portion 16, will not come into direct contact with the user's face. In one embodiment, the facial portion 16 is produced from a fabric having an open weave as shown in FIG. 1. Alternatively, and to further ensure against contamination reaching a user's face, the facial portion 16 may be made of a somewhat stiff material such as a plastic or metal screen, such as wire mesh. A softer and more flexible material (such as fabric) can more easily and naturally come into direct contact with the user's face, particularly the user's eyes. A stiffer material, such as a screen, would tend to resist movement toward the surface of the user's face, and would require pressure to make contact with the facial portion 16. Thus, as shown in FIG. 2, a stiffer facial portion 16 could provide a buffer between parts of the user's face and the facial portion 16.

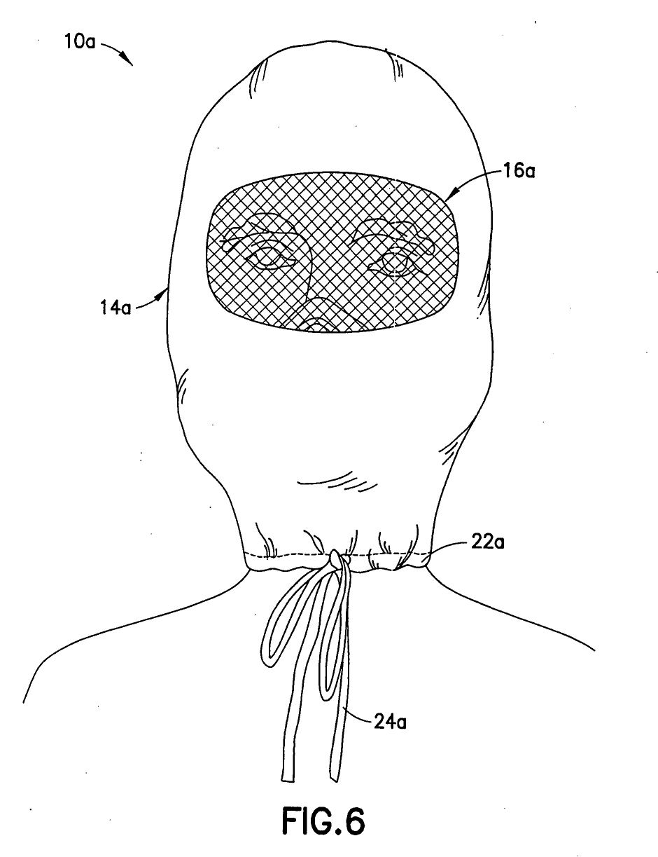

While the facial portion 16, as shown in FIGS. 1-3, covers the entire face, the facial portion 16 can also be made smaller, such that it only covers the area surrounding the user's eyes. FIG. 6 shows such an embodiment of a hood system 10a having a facial portion 16a. The facial portion 16a may be at least sized and configured so that the user can see therethrough in all directions, both directly and peripherally.

Referring to FIGS. 1-3, the hood member 14 also includes a hood portion 20 that is connected to the facial portion 16 at the edges of the facial portion 16, such as by being sewn thereto or otherwise attached thereto in a conventional manner. The hood portion 20 has an open bottom so that the user's head can fit into the hood member 14. The hood portion 20 covers the portion of the user's head that is not covered by the facial portion 16. The hood portion 20 can be made of a flexible material, such as a cloth or fabric made from either natural or synthetic fibers. The flexibility can add to the user's comfort and allows for a good fit to the user's head. The hood portion 20 can also be made from a paper material, for example, like that used in some hospital gowns. Using such paper, since it is a disposable material, the hood system 10 can be discarded after use.

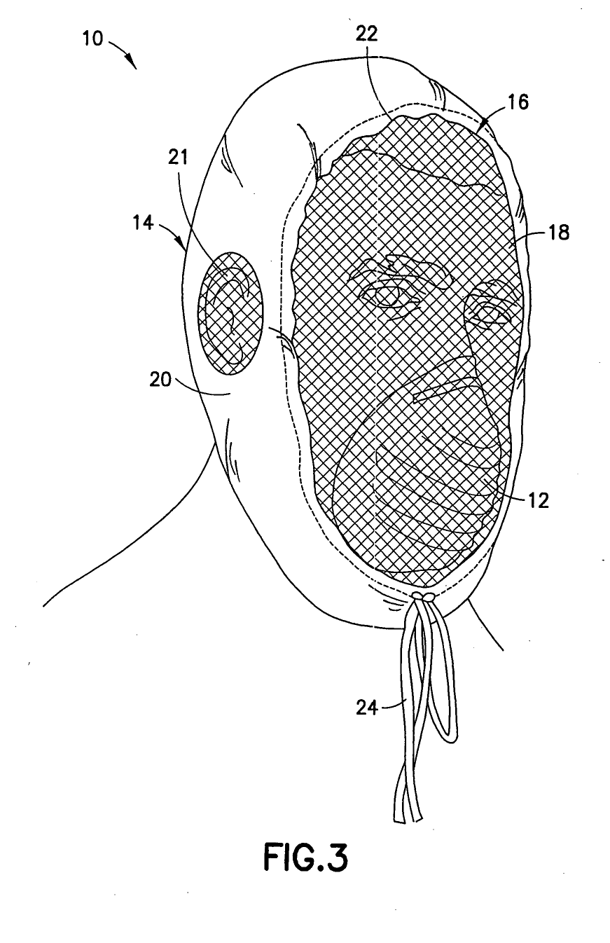

Additionally, the hood portion 20 material can be a cloth or fabric that allows air to permeate through the hood portion 20. This permeability can add to the user's comfort by keeping the inside of the hood portion cool during extended wear. Additionally, such permeability may also allow the user to hear through the hood portion 20. Alternatively, ear panels 21, as shown in FIGS. 2 and 3, can be inserted into the hood portion 20 by cutting holes in the hood portion 20 around the user's ears and replacing the holes with a material that is more permeable, such as the materials that are suitable for the facial portion 16. Such ear panels 21 can allow users to hear better while wearing the hood member 14.

The hood portion 20 includes a channel 22 adjacent to the facial portion 16 that runs along the edge of the facial portion 16. The channel 22 is sewn into or otherwise embedded into or affixed onto the hood portion 20. The channel 22 is configured such that a drawstring 24 can be threaded through the channel 22. Excess string hangs out through two holes at opposite ends of the channel 22 at the bottom of the facial portion 16, such that they can be tied together as shown in FIGS. 1-3. The user ties the ends of the drawstring 24 together to tighten the hood member 14 onto the user's head and face so that the hood member 14 remains in place and is properly oriented as shown in FIGS. 1-3.

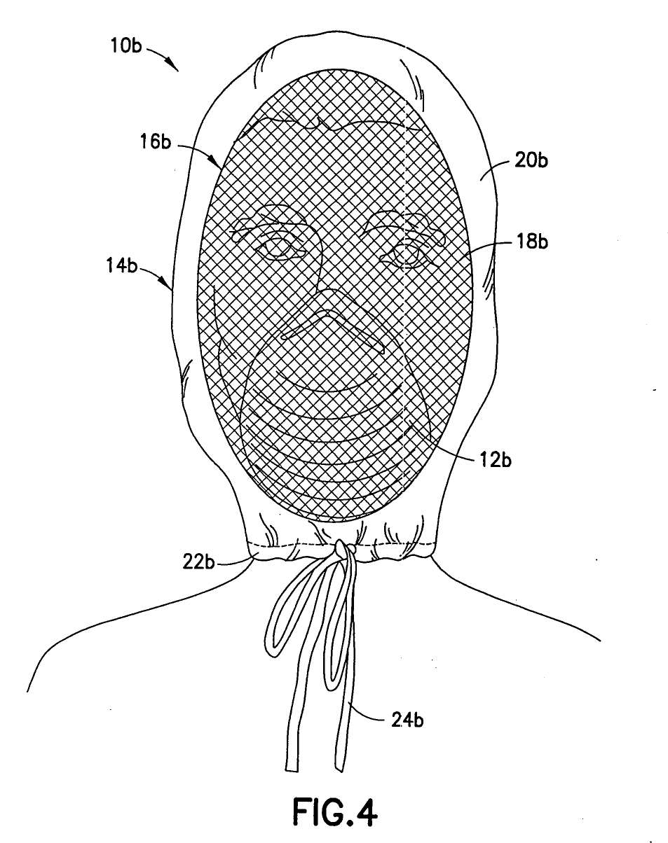

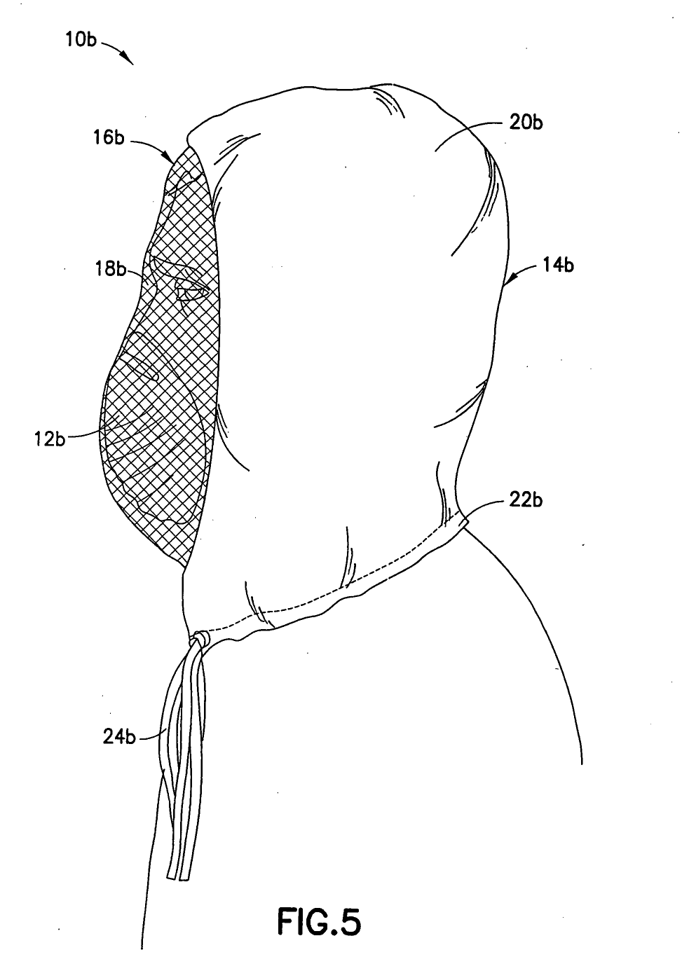

Another embodiment of the respiratory hood system 10b shown in FIGS. 4 and 5 has the channel 22b running around the user's neck at the bottom of the hood portion 20b at the open end. When the user tightens the drawstring and ties it as shown, the hood member 14b remains in place and is properly oriented as shown in FIG. 4.

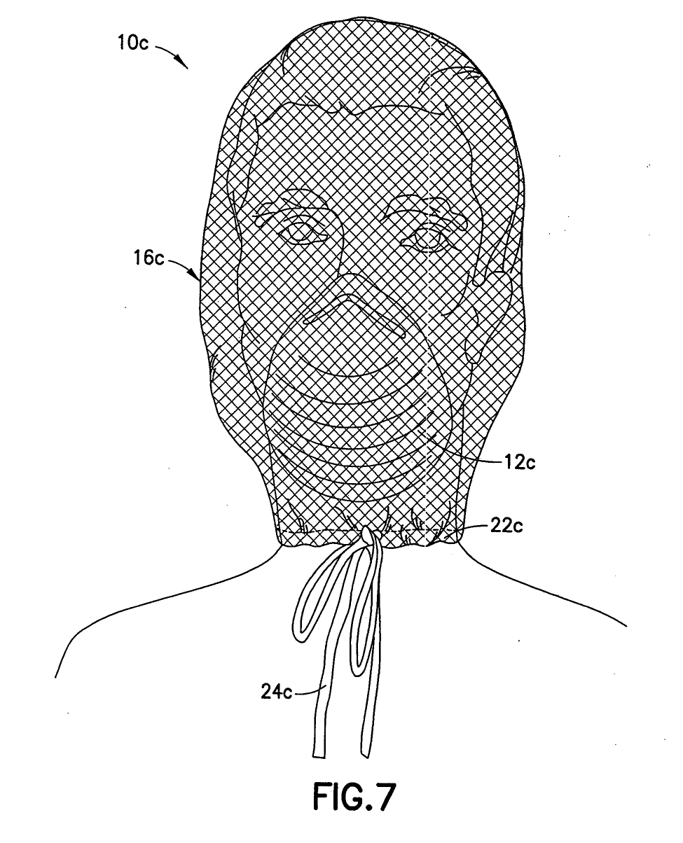

Another embodiment of a respiratory hood system 10c shown in FIG. 7 is similar to that shown in FIGS. 4-6, except that the hood portion 20c is absent and the facial portion 16c extends all the way around the user's head.

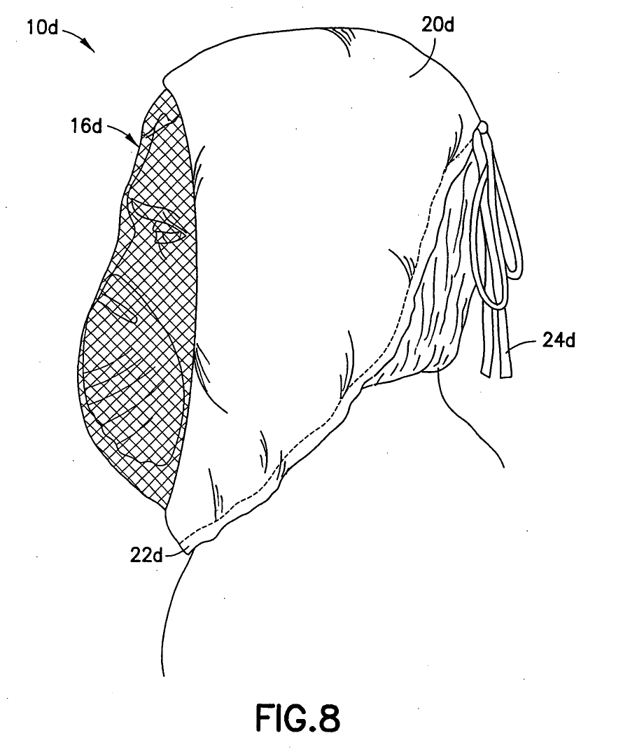

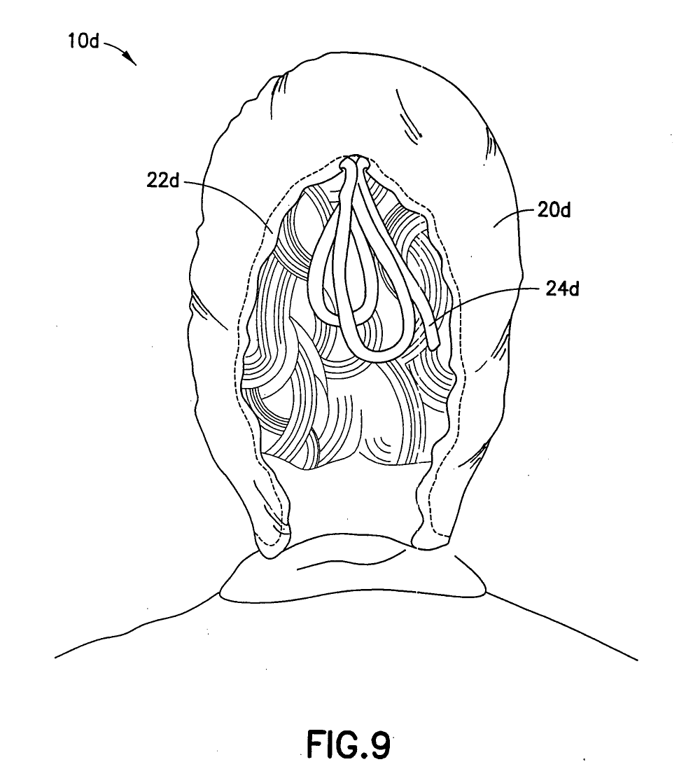

Another embodiment of the respiratory hood system 10d shown in FIGS. 8 and 9 has the hood portion open in the back of the user's head. The channel 22d runs along the bottom of the hood portion 20d and up to the back of the user's head, where the drawstring 24d exits the hood portion 20d and can be tied. When the user tightens the drawstring 24 and ties it as shown, the hood member 14d remains in place and is properly oriented as shown in FIG. 4.

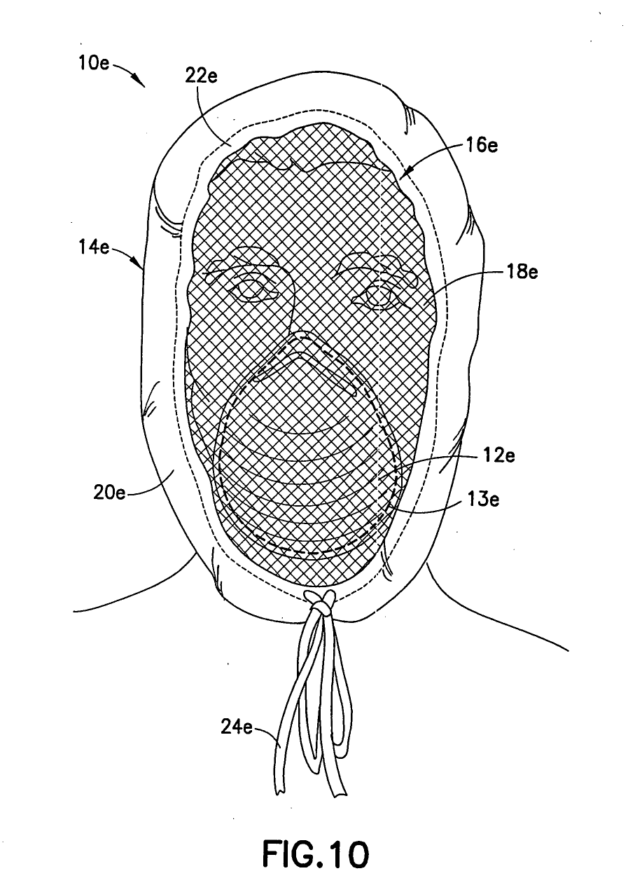

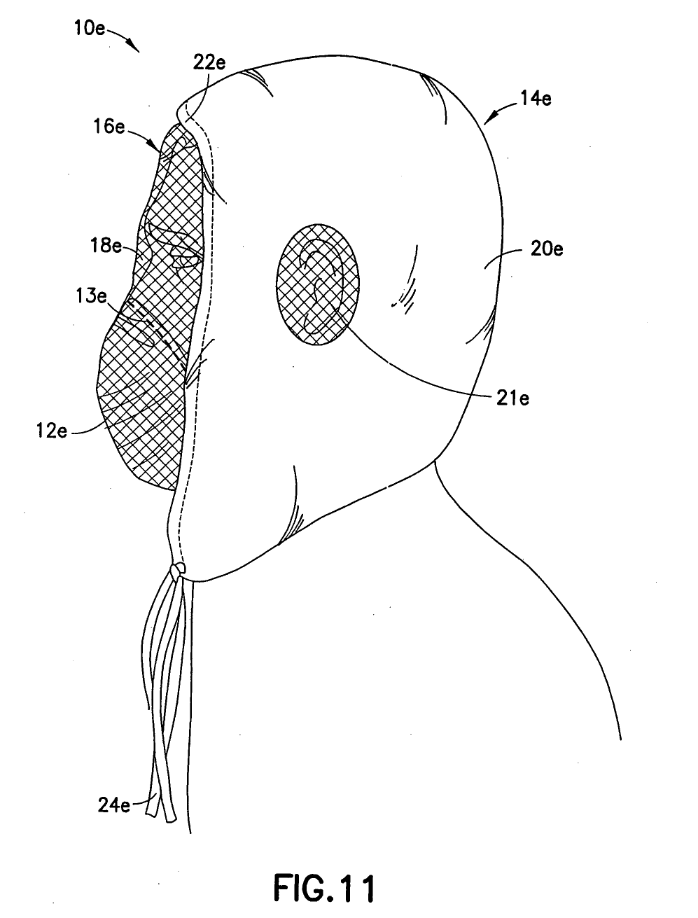

Another embodiment of a respiratory hood system 10e is shown in FIGS. 10 and 11. In this embodiment, the respiratory mask 12e is attached to the facial portion 16e by being stitched to it with stitches 13e. The mask 12e can be also otherwise attached to the facial portion 16e such as being glued to it. Having the mask 12e attached to the facial portion 16e allows the user to avoid having to place the mask 12e on separately from the hood member 14e.

While all embodiments of the respiratory hood system 10 and 10a-e disclosed herein have a drawstring 24 that secures the hood member 14 in place, an elastic band can be threaded through the channel 22 and joined at opposite ends. The elastic can be configured such that it can be stretched to allow the user's head to fit into the hood member 14, and will then contract into its relaxed state so as to secure the hood member 14 in place on the user's head and face, much like the drawstring does. Other variations of attaching and properly securing the hood member 14 onto a user's head are well-known in the art and are regarded as within the scope of the present invention. It would be appreciated by those of ordinary skill in the art that a hood system of the present invention may include one or more features of the embodiments described herein of systems 10, 10a, 10b, 10c, 10d, and 10e. For example, while not shown, hood systems 10, 10a, 10b, 10c, 10d, and 10e may include ear panels 21 or an elastic band (instead of drawstring 24).

The respiratory hood system 10 of the present invention may be used as follows. The user first places the respiratory mask 12 over his or her nose and mouth and secures the mask 12 in place. The user then inserts his or her head in through the opening at the bottom of the hood member 14. The user then arranges the hood member 14 onto the user's face such that the facial portion 16 is properly aligned and the user's vision is unobstructed by the hood portion 20. Alternatively, if the respiratory mask 12e is attached to the facial portion 16e as in the embodiment shown in FIGS. 10 and 11, the user need not separately place the respiratory mask onto his or her head. Rather, the user can place the hood member 14e onto his or her head and arrange the facial portion 16e and the mask 12e together for proper alignment with the user's face.

Once the hood member 14 is properly in place, the user can then pull on the drawstring 24 to tighten the hood member 14 and tie the drawstring 24 to hold the hood member 14 in the proper orientation on the user's head. Once the hood member 14 is so oriented, the user can go about working with or around infected persons without substantial visual or auditory obstruction that would cause the user to be unable to perform their functions. Additionally, the user's breathing will not be obstructed and the user will be protected from contamination. The respiratory mask 24 will protect the user from inhaling any contaminants, while the hood member 14 will protect the user from having contaminated objects, such as the user's hands, come into contact with the user's face. Thus, the respiratory hood system 10 allows those who work in close proximity to infectious diseases to avoid contracting such diseases. The respiratory hood system 10 can also be used in public places such as schools, businesses, grocery and department stores, movie theaters, and other public places such as on public transportation. If worn in such public places during epidemics and especially pandemics (e.g., influenza, avian flu, pneumonia, and others), the respiratory mask system 10 can protect the user from coming into contact with contaminants or disease-causing agents.

The respiratory hood system 10 may be worn during the entire period of time in which the user may be exposed to disease causing agents. The system can be disposed of after use or can be used multiple times and then washed or sanitized. Users may wash their hands after removing the system 10 from their heads to prevent contaminants on the mask 12 and hood member 14 from infecting them, and to prevent users from touching their faces or other portions of their bodies with contaminated hands.

The invention has been described with reference to the desirable embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A respiratory hood system to prevent contaminants from coming into contact with a user's face comprising:
a respiratory mask; and
a hood member, wherein the hood member comprises:
a facial portion that is substantially transparent and breathable, wherein the facial portion does not substantially restrict the user's vision; and
a hood portion attached to the facial portion and configured to cover a portion of the user's head that is not covered by the facial portion.

2. The respiratory hood system of claim 1, wherein the facial portion comprises mesh, netting or screen material.

3. The respiratory hood system of claim 1, wherein the facial portion comprises wire mesh.

4. The respiratory hood system of claim 1, wherein the hood portion comprises cloth, fabric, or paper material.

5. The respiratory hood system of claim 1, further comprising a drawstring threaded through the hood portion to secure the respiratory hood on the user's head.

6. The respiratory hood system of claim 1, further comprising an elastic band threaded through the hood portion, wherein the band is configured to stretch to allow the user's head to fit into the respiratory hood and to contract to secure the respiratory hood on the user's head once the respiratory hood is in place.

7. The respiratory hood system of claim 1, wherein the hood portion further comprises an ear panel.

8. The respiratory hood system of claim 1, wherein the respiratory mask is attached to the facial portion.

9. A respiratory hood for use with a respiratory mask comprising:
a facial portion that is substantially transparent and breathable, wherein the facial portion does not substantially restrict the user's vision; and
a hood portion attached to the facial portion and configured to cover a portion of the user's head that is not covered by the facial portion.

10. The respiratory hood of claim 9, wherein the facial portion comprises mesh, netting or screen material.

11. The respiratory hood of claim 9, wherein the facial portion comprises wire mesh.

12. The respiratory hood of claim 9, wherein the hood portion comprises cloth, fabric, or paper material.

13. The respiratory hood of claim 9, further comprising a drawstring threaded through the hood portion to secure the respiratory hood on the user's head.

14. The respiratory hood of claim 9, further comprising an elastic band threaded through the hood portion, wherein the band is configured to stretch to allow the user's head to fit into the respiratory hood and to contract to secure the respiratory hood on the user's head once the respiratory hood is in place.

15. The respiratory hood of claim 9, wherein the hood portion further comprises an ear panel.

16. A method for protecting contaminants from coming into contact with a user's face comprising:
placing a respiratory mask over the user's nose and mouth; and
placing a respiratory hood over the user's head, wherein the hood comprises:
a facial portion that is substantially transparent and breathable, wherein the facial portion does not substantially restrict the user's vision; and
a hood portion attached to the facial portion and configured to cover a portion of the user's head that is not covered by the facial portion.

17. The method of claim 16, wherein the facial portion comprises mesh, netting or screen material.

18. The method of claim 16, wherein the facial portion comprises wire mesh.

19. The method of claim 16, wherein the hood portion further comprises cloth, fabric, or paper material.

20. The method of claim 16, further comprising a drawstring threaded through the hood portion to secure the respiratory hood on the user's head.

21. The method of claim 16, further comprising an elastic band threaded through the hood portion, wherein the band is configured to stretch to allow the user's head to fit into the respiratory hood and to contract to secure the respiratory hood on the user's head once the respiratory hood is in place.

22. The method of claim 16, wherein the hood portion further comprises an ear panel.
